(19) United States
(12) Patent Application Publication
(10) Pub. No.: US 2026/0084993 A1
(43) Pub. Date: Mar. 26, 2026

(54) METHODS AND SYSTEMS FOR TREATING WATER WITH AN OXIDANT AND UV LIGHT

(71) Applicant: Trojan Technologies Group ULC, London (CA)

(72) Inventors: Mihaela STEFAN, London (CA); Michael Sasges, Victoria (CA); Ferdinando Crapulli, London (CA)

(73) Assignee: Trojan Technologies Group ULC, London (CA)

(21) Appl. No.: 19/223,674

(22) Filed: May 30, 2025

Related U.S. Application Data
(60) Provisional application No. 63/659,468, filed on Jun. 13, 2024.

(51) Int. Cl. C02F 9/00; C02F 1/00; C02F 1/32; C02F 1/42; C02F 1/469; C02F 1/66; C02F 1/76; C02F 101/38

(52) U.S. Cl. CPC C02F 9/00; C02F 1/008; C02F 1/325; C02F 1/42; C02F 1/4693; C02F 1/4695; C02F 1/66; C02F 1/76; C02F 2101/38; C02F 2209/06; C02F 2209/20; C02F 2209/29; C02F 2209/40

(57) ABSTRACT

Methods and systems are provided for treating water to remove urea from the water by controlling the pH of the water to be in a range of from 3.5 to 5, adding an oxidant to the water, and then subjecting the water to UV radiation to decompose the urea.

### CROSS-REFERENCE TO RELATED APPLICATION

This application claims the earlier filing date of U.S. Provisional Application No. 63/659,468, filed on Jun. 13, 2024, the entirety of which is incorporated by reference herein.

### TECHNICAL FIELD

This invention relates generally to treating water with an oxidant and ultraviolet light to remove organic compounds from the water, and more specifically to methods of removing urea from water with such a treatment.

### BACKGROUND

Urea and other recalcitrant organic compounds are pollutants that are widely present in water sources and are difficult to remove. In industries that require ultrapure water (UPW), such as semiconductor manufacturing, urea in particular is considered to be a persistent pollutant that can threaten the manufacturing yield or cause product defects. Also, in other applications the presence of urea in water can cause health problems in humans since urea is toxic.

Currently available methods for removing urea from water are either only marginally effective or require an extensive series of various removal or purification processes to achieve the desired level of water quality.

### SUMMARY

The methods and systems described in this application provide an efficient and effective way to remove urea from water. In one aspect, this disclosure provides a method for treating water to remove urea from the water. The method includes steps of adding a sufficient amount of a pH adjusting agent to the water to control the pH of the water to be in a range of from 3.5 to 5, adding a chlorine-containing agent to the water, and then irradiating the water with UV radiation to decompose the urea in the water so that at least 60% of the urea in the water is removed.

In another aspect, this disclosure provides a system for treating a water stream to remove urea from the water stream, which includes (i) a UV reactor that is configured to receive the water stream and irradiate it with UV radiation to provide a UV-treated water stream, (ii) an acid source that is arranged upstream of the UV reactor and is configured to add acid to the water stream, (iii) a chlorine source that is arranged upstream of the UV reactor and is configured to add a chlorine-containing agent to the water stream, (iv) a controller that includes a processor, (v) an upstream pH meter that is arranged upstream of the UV reactor and is configured to measure the pH of the water stream and send a signal to the controller based on the measured pH, and (vi) an upstream TOC analyzer that is arranged upstream of the UV reactor and is configured to measure a TOC concentration in the water stream and send a signal to the controller based on the measured TOC concentration. The controller is configured to compare the measured TOC concentration with a threshold value, and if the measured TOC concentration exceeds the threshold value, the controller can (i) send a control signal to control the acid source based on the measured pH so that an amount of acid is added to the water stream to control the pH to be in a range of from 3.5 to 5, and (ii) send a control signal to control the chlorine source so that the chlorine-containing agent is added to the water stream.

In yet another aspect, this disclosure provides a system for treating a water stream to remove urea from the water stream, which includes (i) a UV reactor that is configured to receive the water stream and irradiate it with UV radiation to provide a UV-treated water stream, (ii) an acid source that is arranged upstream of the UV reactor and is configured to add acid to the water stream, (iii) an oxidant source that is arranged upstream of the UV reactor and is configured to add an oxidant to the water stream, (iv) a controller that includes a processor, (v) an upstream pH meter that is arranged upstream of the UV reactor and is configured to measure the pH of the water stream and send a signal to the controller based on the measured pH, and (vi) an upstream TOC analyzer that is arranged upstream of the UV reactor, and includes (a) a first TOC analyzer that is sensitive to urea that is configured to measure a first TOC concentration of the water stream and send a signal to the controller based on the measured first TOC concentration; (b) a second TOC analyzer that is not sensitive to urea that is configured to measure a second TOC concentration of the water stream and send a signal to the controller based on the measured second TOC concentration. The controller is configured to calculate a difference between the measured first TOC concentration and the measured second TOC concentration, and if the difference exceeds a threshold value, the controller can (i) send a control signal to control the acid source based on the measured pH so that an amount of acid is added to adjust the pH of the water stream, and (ii) send a control signal to control the oxidant source so that the oxidant is added to the water stream.

### BRIEF DESCRIPTION OF THE DRAWINGS

FIG. 1 is a schematic diagram of a system for removing urea from water with a UV treatment according to one embodiment;

FIG. 2 is a schematic diagram of a UV treatment system that includes a standby oxidant-UV treatment according to one embodiment;

FIG. 3 is a schematic diagram of a UPW process that includes an oxidant-UV treatment;

FIG. 4 is a graph illustrating the effectiveness of a chlorine-UV treatment in urea removal;

FIG. 5 is a graph illustrating the effect of dissolved oxygen and the use of different UV lamps on urea removal; and

FIG. 6 is a graph illustrating the effect of the amount of chlorine-containing agent on urea removal.

### DETAILED DESCRIPTION OF EMBODIMENTS

This disclosure provides for methods and systems for removing urea and other organic contaminants from water. The term “water” as used herein means any aqueous source that is at least 75 wt. % water, such as at least 99 wt. % water or 99.5 wt. % water, for example. The term “removing” as used in the context of removing organic contaminants will be understood to include decomposing or converting the contaminants into other compounds.

The methods and systems described herein can achieve excellent removal of urea from water. In one aspect, the methods include controlling the pH of the water to be within a range of 3.5 to 5, adding an oxidant source to the water, and irradiating the water with UV light to remove at least 60% of the urea from the water. The pH of the UV-treated water can be optionally raised after the UV treatment, and the treated water can optionally be passed through an ion exchange resin or other deionization device to remove ions generated during the UV treatment. In some cases, the methods and systems described herein can remove at least 65% of the urea from the water, at least 75% of the urea from the water, such as from 75% to 90%, for example. The urea may be removed to lower than 25 ppb (i.e., micrograms/L), lower than 10 ppb, lower than 5 ppb, lower than 1 ppb, lower than 0.2 ppb, including, e.g., from 0.05 ppb to 10 ppb. Where the concentration of urea in the water is quantified herein, it should be determined using high-performance liquid chromatography (HPLC) with a fluorescence detector.

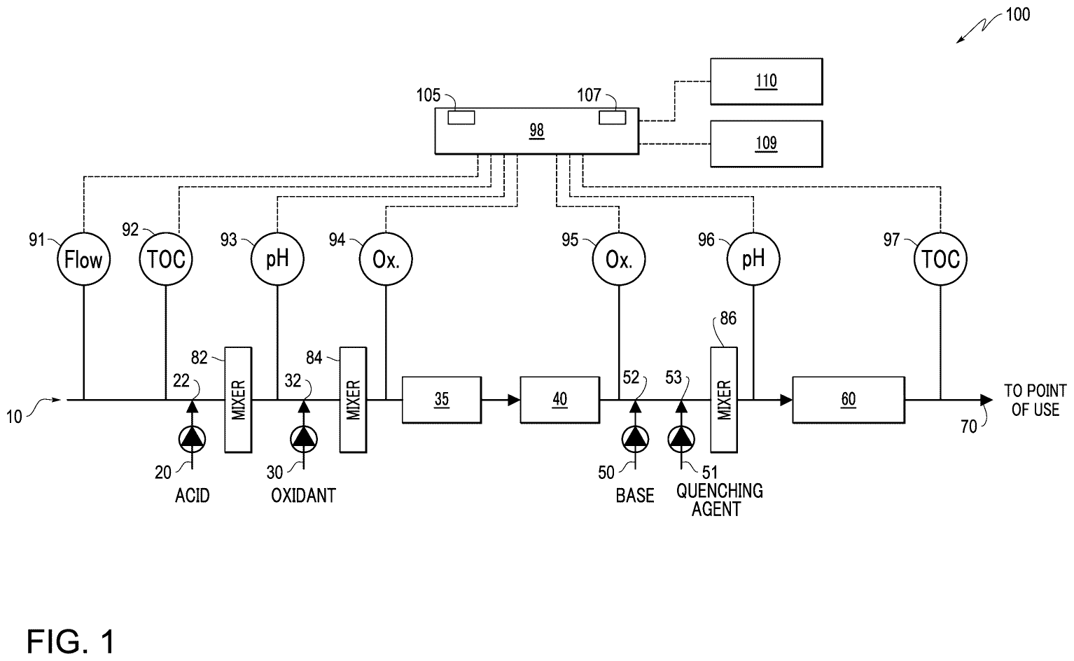

FIG. 1 is a schematic diagram illustrating an exemplary system for removing urea from water. The system 100 includes an inlet 10 for receiving the water to be treated, and acid source 20 having an acid that is combined with the water at junction 22, an oxidant source 30 having an oxidant that is combined with the water at junction 32, an optional holding tank 35, a UV reactor 40 that irradiates the water with UV light as the water flows through the reactor, a base source 50 having a base that is combined with the treated water at junction 52, a quenching agent source 51 having a quenching agent that is combined with the treated water at junction 53, an ion exchange device or other deionization system 60, and an outlet 70 that sends the treated water toward a point of use, such as a clean room in a semiconductor manufacturing facility.

The system can also include one or more mixers 82, 84, 86, such as dynamic or static mixers, that are downstream of the junctions 22, 32, and 52 to uniformly mix the reagents with the water. The system can also include a flow meter 91 upstream of the UV reactor 40, a TOC analyzer 92 that is upstream of the UV reactor 40, an upstream pH meter 93, an upstream oxidant analyzer 94, an oxidant analyzer 95 that is downstream of the UV reactor 40, a downstream pH meter 96, and a downstream TOC analyzer 97. Although FIG. 1 depicts the flow meter 91 upstream of the TOC analyzer 92, the flow meter 91 can be positioned anywhere along the flow path of system 100. Likewise the order of the meters/analyzer is not limited to the specific arrangement shown in FIG. 1. The meters/analyzers can all send signals indicative of the measured values to an automated controller 98. The automated controller 98 can also communicate with pumps and/or valves that are connected to each of the acid source 20, oxidant source 30, and base source 50, and to the UV reactor as described in more detail below. The controller can include a processor (e.g., processor 105) and a memory (e.g., memory 107). The controller 98 may optionally include a display and user interface or may, alternatively, transmit information and control signals to a display (e.g., display 109; user interface 110). The memory can store information (for example, programs, various data, set points, threshold values, etc.) some of which can be input by the user interface 110, and the processor functions based on the information stored in the memory.

The TOC analyzer 92 can measure the total organic carbon (TOC) in the water that enters system 100, including urea. In one aspect, the TOC analyzer 92 can be used to measure the TOC, and if the TOC is above a threshold value, the water can be treated with the chlorine-UV treatment described above. By way of example, in UPW systems the water may typically have very low levels of background TOC (e.g., less than 5 ppb or even less than 1 ppb), in which case the oxidant-UV treatment may not be necessary. However, in certain circumstances, urea can appear in the water supply which will cause the TOC levels to rise. For example, if the TOC exceeds levels of 5 ppb (e.g., values in a range of 3 ppb to 10 ppb could be typical if there is a spike in urea levels), it may be determined that a urea event has occurred that requires oxidant-UV treatment. In another aspect, the specific amount of oxidant added and/or the degree of UV radiation can be determined based on the measured TOC and optionally the measured flow rate. When the TOC is measured with a single TOC analyzer as shown in FIG. 1, the measured TOC value will include urea but can also include other organic compounds. In some applications, this technique may be sufficient to infer the amount of urea in the water for purposes of identifying urea events or determining the amount of oxidant or UV radiation.

In other applications, the TOC analyzer 92 can be arranged to specifically identify the presence of urea by using two different types of TOC analyzers located at the same position in the system. In this regard, some TOC analyzers respond to urea (e.g., membrane-type analyzers such as Sievers) while others exhibit little or no response to urea (e.g., analyzers without membranes such as Anatel). See, e.g., U.S. Pat. No. 7,662,637, which is incorporated by reference herein. By measuring the TOC of the water with each type of analyzer, the difference between the two readings can give an accurate representation of the urea concentration in the water. The use of these two types of TOC analyzers provides a relatively simple way to quickly infer the amount of urea in the water, whereas conventionally facilities would need to send water samples to third party laboratories to get accurate urea readings, which can take several days. Similar to above, this difference can also be compared to a threshold to determine if a urea event has occurred in the water system (i.e., determine whether urea needs to be removed with the oxidant-UV treatment), or to determine the specific levels of urea in the system so that the amount of oxidant and/or UV radiation can be controlled accordingly. In particular, the automated controller 98 can receive signals from the TOC analyzer 92 and the processor 105 can compare the measured TOC values with threshold values stored in the memory 107 to determine whether a urea event has occurred that requires oxidant-UV treatment. The automated controller 98 can also be programmed to determine the amount of oxidant that is added and UV energy that is applied based on the measured TOC value and optionally the measured flow rate. The controller 98 can also send control signals to valves, lamp drivers, or other equipment to control the UV dose received by the water as it flows through the reactor by varying flow rate and/or UV power. The controller 98 can send signals to pumps and/or valves in communication with the acid source 20 and oxidant source 30 to control the amount of acid and oxidant that is added to the water based on the measured TOC values, the measured pH value, and/or the measured flow rate.

The acid source 20 adds a sufficient amount of acid to the water to adjust the pH to be within a specific range. Any type of mineral acid can be used. It has been discovered in connection with this disclosure that the specific pH range significantly affects the rate at which the urea decays and the quantity of urea that can be removed. The pH of the water can be adjusted to within a range of from 3.5 to 5, as indicated above, from 3.7 to 4.8, from 3.8 to 4.6, or from 4 to 4.5, for example. Generally, the pH of water in most water systems will be higher than these ranges and can be adjusted to the identified ranges by adding an acid as shown in FIG. 1, but if the pH of the water at the inlet were lower than these ranges, the pH could instead be adjusted with a base to be within these ranges. The pH of the water can be controlled by measuring the pH with pH meter 93 downstream of junction 22 and adding a sufficient amount of acid or base until the pH of the water is within the desired range or reaches the desired level. In particular, the automated controller 98 can receive a signal from the pH meter 93 that is indicative of the measured pH value, the processor 105 can compare the measured value with a range or set point pH stored in memory 107, and can send signals to pumps and/or valves in communication with the acid source 20 to add a sufficient amount of acid to the water until the measured pH value reaches the set point value or is within the preset range.

The oxidant source 30 can include an oxidant such as a chlorine-containing agent, a persulfate, or peroxide. The chlorine-containing agent can be a compound that produces free chlorine in the water such as hypochlorite salt such as sodium hypochlorite or calcium hypochlorite, which can be added to the water as an aqueous solution (i.e., bleach, which is typically 2 to 15 wt. % hypochlorite), or a chloride salt. Without intending to be bound by theory, where chlorine is used as the oxidant, urea can be removed to very low levels using the methods and systems described herein because the chlorine-containing agent will rapidly equilibrate with acidic water that is within the above-identified pH ranges to produce predominantly hypochlorous acid (HOCl) that can effectively oxidize the urea and decompose it in the presence of UV light. Using lower pH values can result in the formation of gaseous chlorine, which is a health hazard. It is also believed that pH values lower than the claimed range would favor formation of chlorourea derivatives, whose degradation mechanism and kinetics with an oxidant-UV process are not described in the public domain.

The system 100 can include an oxidant analyzer 94 upstream of the reactor that can measure the concentration of oxidant in the water (e.g., a chlorine analyzer that can measure, e.g., free chlorine, if the oxidant is hypochlorite) to ensure that a sufficient amount of oxidant is present to achieve the desired level of removal of urea, and the automated controller 98 can control the dosing of oxidant based on the measured value from oxidant analyzer 94. By way of example, the oxidant can be dosed so that the water before the reactor has an amount of oxidant (e.g., free chlorine, HOCl if the oxidant is hypochlorite) that is in a range of 0.5 ppm to 100 ppm, from 1 ppm to 50 ppm, or from 2 ppm to 15 ppm, for example. The oxidant can also be dosed based on the measured amount of TOC and measured flow rate so that, on a weight basis the ratio of the amount of oxidant (e.g., free chlorine) to the amount of TOC is in a range of from 10:1 to 1000:1, from 50:1 to 500:1, or from 100:1 to 500:1. The oxidant can be dosed automatically by the automated controller 98 based on measured TOC values and measured flow rate or based on the inferred urea concentration as explained above.

Although the FIG. 1 embodiment shows the acid source upstream of the oxidant source, the order of addition of the acid and the oxidant not so limited, and either component can be added first or both components can be added together or simultaneously.

Optionally, once the acid and oxidant are added to the water, the system can be configured so that the water is held for a period of time prior to being sent to the UV reactor 40 and irradiated with UV radiation. For example, as shown in FIG. 1, an additional tank 35 can be added downstream of the acid and oxidant sources that holds the water for a period of time before the water is sent to the UV reactor 40, or, alternatively, a specific length of a conduit could be used upstream of the UV reactor 40 to hold the water for a longer period than normal. In some embodiments, once the last of the acid or antioxidant are added to the water, the holding period before the water is sent to the reactor and irradiated with UV radiation can be in a range of from 2 minutes to 1 hour, from 5 minutes to 40 minutes, or from 10 to 30 minutes, for example. It has been discovered that this type of “hold” step after the acid and oxidant are added to the water can enable a reduction in the amount of subsequent UV treatment that is required.

The water that includes the oxidant is fed to the UV reactor 40 where it is irradiated with UV light as it flows through the reactor. The UV reactor 40 can include one or more UV light sources (e.g., UV-LEDs or UV mercury lamps). The UV light sources can emit radiation that is within the UV spectrum or Vacuum Ultraviolet (VUV) spectrum, i.e., in a range of from 10 nm to 400 nm, 150 nm to 300 nm, or more specifically at 185 nm, 220 nm, 235 nm, and/or 254 nm, for example. As described in the Examples below, in some embodiments, the water can be treated with UV radiation having a single wavelength (e.g., by using a dedicated high-dose reactor emitting only 254 nm UV radiation), and in some embodiments can be treated with UV radiation having multiple wavelengths (e.g., by using a combination of a UV light source that emits 185 nm light and a UV light source that emits 254 nm light). The UV reactor is not limited to any particular arrangement of the UV light sources or the flow path of the water within the reactor. The energy output of the UV light can be varied by lamp driver power, choice of lamp, or the number of lamps that are arranged to emit UV light through the water that is being treated. It would also be possible to modify system 100 so that multiple UV reactors are used in parallel or series to treat the water with the oxidant to increase the energy output. The automated controller 98 can send signals to the UV reactor 40 to control the UV radiation based on the measured levels of TOC and optionally based on the measured flow rate. The automated controller 98 at also send signals to valves that control the flow rate of water upstream of the UV reactor 40 to restrict the flow through the UV reactor 40 based on the measured levels of TOC (e.g., if a urea event is detected) so that that the UV energy supplied to the water increases.

The system 100 can include an oxidant analyzer 95 downstream of the UV reactor 40 to ensure that a sufficient amount of the oxidant is consumed by the UV process, e.g., to ensure that the oxidant is below a threshold value. If excess oxidant is present, the control system could decrease the amount of oxidant added upstream, or increase the UV dose applied. This allows for an iterative determination of the amount of oxidant needed for TOC reduction, which could be useful if the origin of the TOC is not predictable or degrades at an unexpected rate. The system may also incorporate a quenching agent source 51 to introduce a chemical quenching agent to the water at junction 43. The chemical quenching agent is added to degrade the residual oxidant present in the water and may include at least one of hydrogen peroxide, sodium sulfite, sodium thiosulfate, and ascorbic acid. High values of residual oxidant may be harmful to the downstream process or equipment, so it is beneficial to ensure that the applied UV dose or quenching agent is sufficient to degrade the oxidant.

The base source 50 can be added in sufficient amounts to increase the pH to around a neutral pH (e.g., from 5.5 to 8.5) or otherwise to a pH that is suitable for the downstream process or ion exchange device or other deionization system 60 (e.g., 6 to 8.0). The pH meter 96 measures the pH downstream of junction 52 to ensure that sufficient base is added to reach the target pH. The pH meter 96 can send a control signal to controller 98 based on the measured pH of the water downstream of the UV reactor 40, and the controller 98 can send control signals to control the amount of base that is added at base source 50 so that the pH is within the predetermined range or above a predetermined threshold.

The ion exchange device or other deionization device 60 receives the treated water and removes ions that were put into the water with the oxidant-UV treatment, such as chloride ions and other ions. The ion exchange device can include an ion exchange media such as a cationic resin that is able to remove chloride ions or other anions from the water. An anion exchange resin can also be included to remove anions from the water or a mixture of cation and anion exchange resins can be included. The ion exchange media can be arranged serially in layers or columns, and the water can be passed over the ion exchange media to remove the ions of interest. Other suitable deionization devices may include an electrically-driven ion purification apparatus, such as an electrodialysis apparatus or an electrodeionization apparatus.

Another TOC analyzer 97 can be provided downstream of the UV reactor 40 to measure the TOC content to confirm that urea and its organic degradation byproducts have been removed from the treated water (i.e., that it is below a threshold value). The TOC analyzer 97 can either be based on a single TOC analyzer that is sensitive to urea or can calculate a difference between the measured values of two types of TOC analyzers in the same manner described above in connection with TOC analyzer 92.

The automated controller 98 can be configured to automate the oxidant-UV treatment process, in the manner described above by receiving signals from one or more of the flow meter 91, the TOC analyzers 92, 97, pH meters 93, 96, and oxidant analyzers 94, 95, either wired or wirelessly over a network, that are indicative of the measured values, and sending control signals to one or more of the pumps and/or valves associated with the acid source 20, oxidant source 30, and base source 50, and to the UV reactor 40. The controller 98 can be a physical server or circuitry of a physical server or other computer. Alternatively, the controller 98 may be a cloud server, or virtual circuitry of an abstraction layer of a cloud server, running in a cloud computing environment on the Internet. The functions of the processor may be realized by individual hardware, or may be realized by integrated hardware. Alternatively, the processor, the memory, display, and user interface may be partially or completely remotely arranged with respect to each other, for example connected to the processor via a network (not shown). The processor may be, for example, a central processing unit (CPU). However, the processor is not limited to a CPU, and various processors such as a graphics processing unit (GPU) or a digital signal processor (DSP) can be used. The processor may be a hardware circuit based on an application-specific integrated circuit (ASIC). The term “processor” encompasses a single processor or a group of multiple processors located either locally or remotely working together or in a distributed fashion to collectively perform the tasks attributed to the “processor” described herein.

The system 100 can be effective to remove urea from the water in the amounts described above, e.g., at least 50% removal or to less than 25 ppb as urea or less than 5 ppb, or less than 1 ppb. In addition to urea removal, the methods and systems described herein may also be effective to remove other organic compounds, in particular other small organic compounds, including, e.g., those having a molecular weight in a range of from 25 g/mol to 125 g/mol such as chloroform.

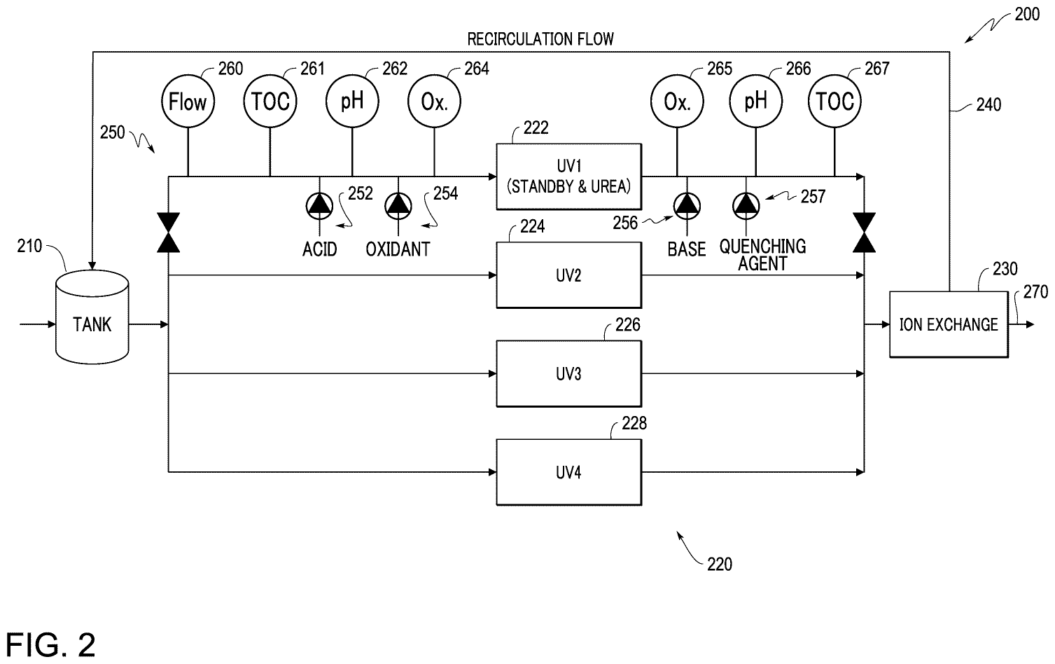

FIG. 2 illustrates an embodiment of a UV treatment system 200 that includes a standby oxidant-UV treatment system 250. The UV treatment system may form part of the UPW processing system as described below. The system 200 includes a tank 210 that receives water and feeds water to UV reactor system 220 that includes multiple UV reactors in parallel 222, 224, 226, 228 that can treat the water with UV radiation. The treated water can then be sent to an ion exchange or other deionization device 230 to remove ion products. A recirculation flow loop 240 can recirculate treated water upstream of the UV reactor system 220, e.g., to tank 210. The recirculation loop 240 allows the flow rate to remain high while still treating the water with sufficient UV radiation in the UV reactor system 220. The system 200 also includes an outlet 270 where treated water is sent toward a point of use or toward additional treatment equipment.

An oxidant-UV treatment system 250 can be arranged similarly to the FIG. 1 embodiment including an acid source 252, oxidant source 254, UV reactor 222, base source 256, and quenching agent source 257, as well as flow meter 260, upstream TOC analyzer 261, upstream pH meter 262, upstream oxidant analyzer 264, downstream oxidant analyzer 265, downstream pH meter 266, and a downstream TOC analyzer 267 to measure TOC content to confirm that urea and its organic degradation byproducts have been removed from the treated water (i.e., that it is below a threshold value). Although not illustrated, the system 200 can also include the automated controller and associated control system as described in the FIG. 1 embodiment, which are in communication with each of the meters/analyzers, and can include various mixers as described in the FIG. 1 embodiment. The system 200 can also optionally include a “hold” step downstream of the acid source 252 and oxidant source 254 and upstream of the UV reactor 222, as described in the FIG. 1 embodiment. With the arrangement shown in FIG. 2, in case a urea event is detected (e.g., TOC exceeds a certain threshold as described above), the flow can be reduced to the oxidant-UV treatment system 250 (to increase the UV dose) relative to the other UV reactors in system 220, and the water can be treated with a similar oxidant-UV treatment as described above, i.e., the acid can be added to the water to adjust the pH to be within the above-identified ranges, an oxidant can be added to the water, the UV reactor 222 can emit UV radiation to form the radicals that will degrade the urea, a base can be added to the UV-treated water to increase the pH, and optionally a quenching chemical can be added to degrade excess residual oxidant. In the above described system, the UV reactor 222 can remain active even where there is no urea event. In other embodiments, the entire oxidant-UV treatment system 250 can remain offline or on standby until a urea event is detected. In the case the oxidant-UV treatment system 220 is active and even if the flow through system 250 is reduced, the overall flow of water through the system 200 is largely unchanged, and the recirculation loop 240 enables substantially all of the urea to be removed over time, including to within the ranges described above.

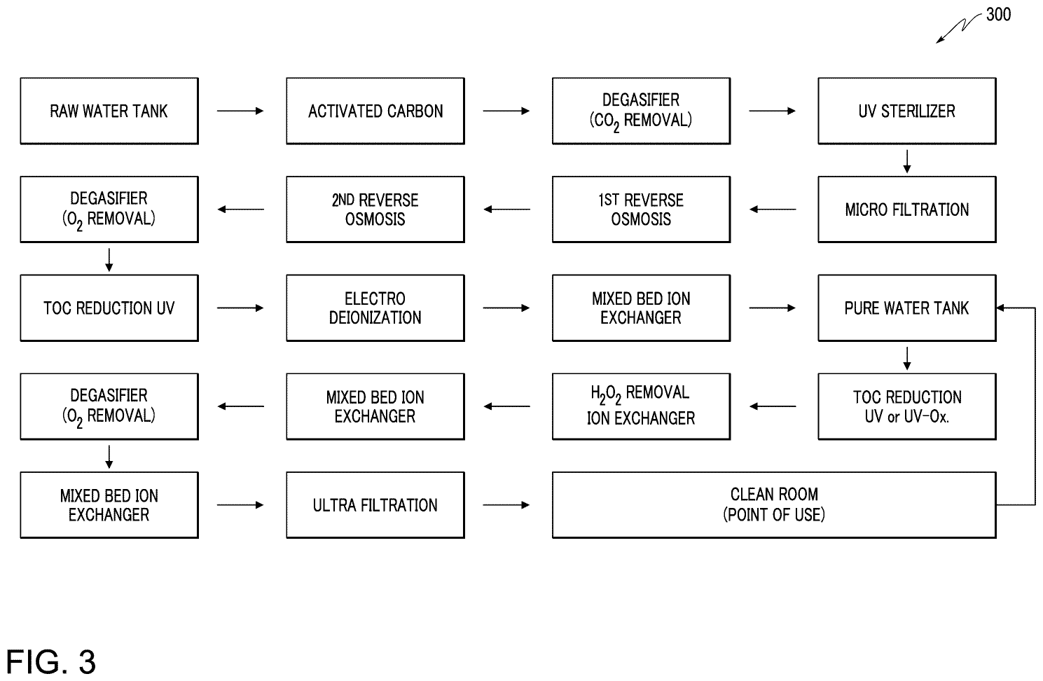

FIG. 3 is a schematic diagram of a typical UPW process 300 in a semiconductor manufacturing plant that illustrates the several stages of purification processes that are needed to remove various contaminants and transform raw water into UPW that can be used in a clean room, e.g., in the wet cleaning, wet etching steps, or rinsing steps of semiconductor manufacturing. When the methods and systems described herein are implemented in this type of UPW process to remove urea, they can be arranged as shown in the “TOC Reduction UV or UV-Ox” stage, or may be arranged in the “TOC Reduction UV” stage. In addition to semiconductor manufacturing, the methods and systems can be used to remove urea from UPW in display manufacturing and microelectronics manufacturing, for example.

### Example 1

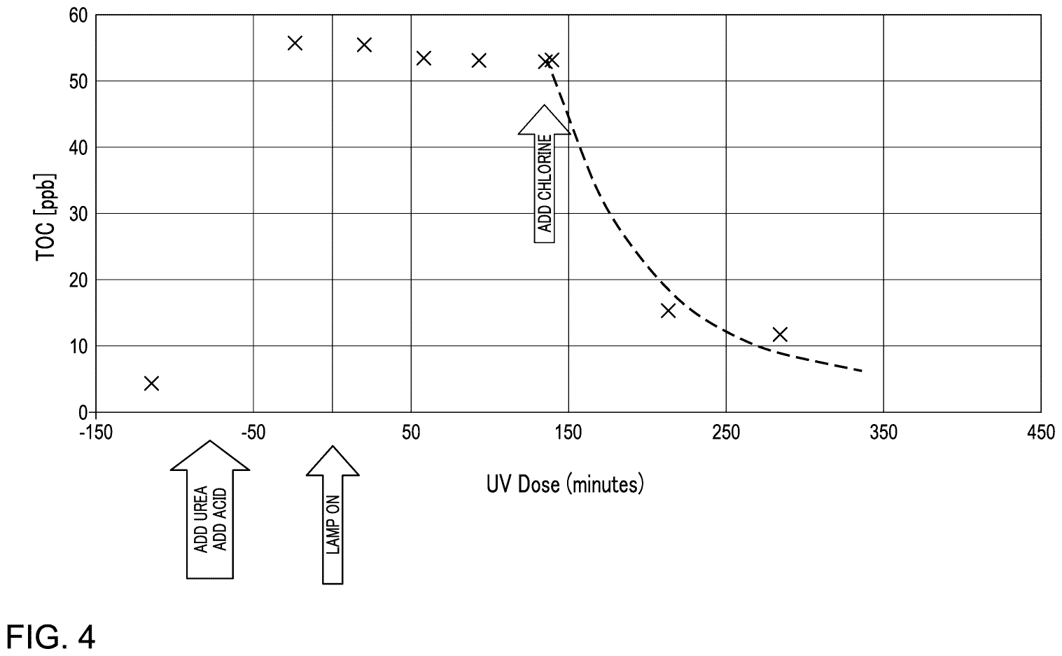

FIG. 4 is a graph of experimental data showing water treated with a chlorine-UV treatment according to the methods described herein. The background TOC in the water used for the experiment was about 5 ppb (shown at the approximately −120 minute mark). To this water, urea is added to provide a total TOC of about 55 ppb (−25 minute mark). Then, acid was added to the water until the water reached a pH of about 4.3. Once the system was stable, the UV lamp (254 nm) was turned on (0 minute mark), and the levels of total TOC were measured at various times. The chlorine-containing agent is added as bleach at minute 145 to achieve a concentration of 4.5 mg/L of free chlorine.

As can be seen, the TOC levels drop only slightly from minute 0 up until the chlorine is added, which indicates that the combination of UV light and an acidic pH are not sufficient alone to remove urea. After the chlorine is added to the water, the measured TOC value immediately drops and does not require any period of equilibrating with the acid. This result is contrary to postulated mechanisms described in the art for a reaction between free chlorine and urea, in which it has been proposed that chlorinated urea are formed in a series of steps including a first rate-limiting step that requires molecular chlorine (Cl₂) to proceed. The pH used in Example 1 was held at about 4.3, and there would be virtually no molecular chlorine in the form of Cl₂ present in the solution at this pH. Thus, at the pH values used in this invention, it is believed that the reaction between chlorine and urea likely does not form chlorourea. This seems to be beneficial for the removal of urea in the chlorine-UV treatment since the rate of urea decomposition at pH values in a range of 3.5 to 5 is rapid.

The results of Example 1 show that the TOC value also drops exponentially over time, and is reduced to about 12 ppb over 100 minutes (about a 78% removal). This demonstrates that the use of an oxidant such as chlorine in combination with a UV treatment at certain pH values can be very effective to remove urea, and its potential byproducts, and can achieve very low residual levels of urea.

### Example 2

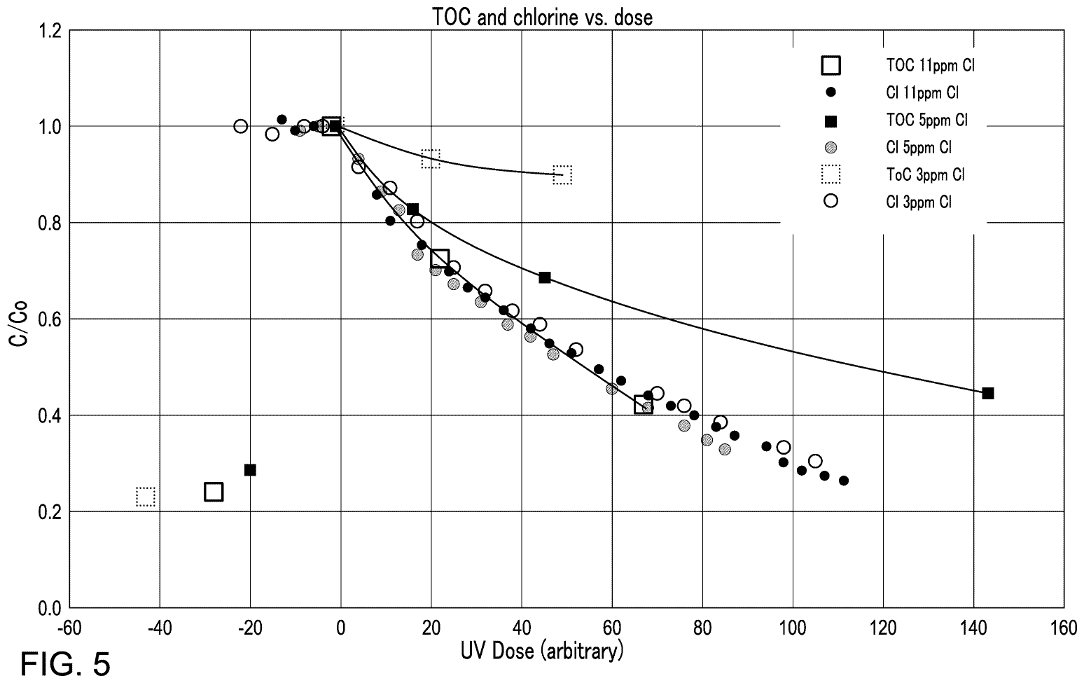

FIG. 5 is a graph of experimental data showing the effect of the chlorine dose on urea removal. In this experiment the y-axis is a normalized concentration of the TOC and chlorine. The TOC is normalized by the value after addition of urea, and the chlorine is normalized by the maximum value so that both TOC and urea have starting normalized C/C₀ values of 1. Three different concentrations of chlorine were used to consider the effects of the chlorine dosing—11 ppm, 5 ppm, and 3 ppm. The dots show the free chlorine concentration over time. The data in FIG. 5 demonstrates that the chlorine decay is exponential with UV dose, and the slope of the decay does not appear to depend significantly on the chlorine concentration.

By contrast, the decay of TOC is highly dependent on the chlorine concentration, in which higher levels of chlorine cause a more rapid degradation of TOC as compared to lower levels. Since the TOC in this experiment was comprised predominantly of urea, this shows that the rate of removal of urea will also be dependent on the chlorine concentration, and thus the chlorine can be dosed based on the measured TOC or urea concentration, as described above.

### Example 3

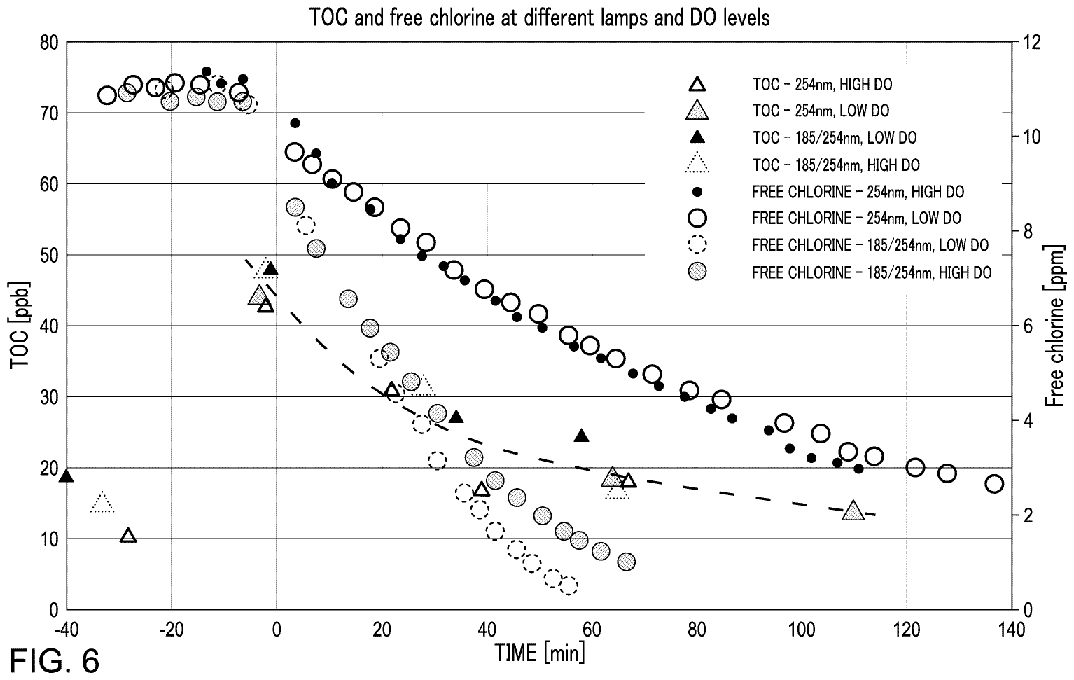

FIG. 6 is a graph of experimental data showing the effect of the UV lamp wavelength and dissolved oxygen on urea removal. In the FIG. 6, the initial urea concentration in the water is about 45 ppb as TOC, the chlorine concentration is dosed at about 11 ppm free chlorine, and the pH is adjusted to be about 4. Tests were done with high and low dissolved oxygen, and with either (i) a combination of 185 nm UV light and 254 nm UV light; or (ii) only 254 nm UV light.

From the experimental data, it can be seen that the rate of urea destruction (as TOC), shown as triangles, is substantially the same or within experimental uncertainty regardless of the degree of dissolved oxygen and regardless of whether 185 nm UV light is present or not. Thus, in the methods and systems described herein, it is possible to achieve substantially the same results by using only a 254 nm light source, and there may not be any significant advantage in using 185 nm VUV radiation with 254 nm UV radiation. However, the use of 185 nm VUV radiation in addition to 254 nm UV radiation increased the rate of chlorine conversion, which is shown as circles. Thus the use of 185nm would entail greater consumption of chlorine and greater formation of chloride ions that may need to be removed downstream.

It will be appreciated that the above-disclosed features and functions, or alternatives thereof, may be desirably combined into different systems and methods. Also, various alternatives, modifications, variations or improvements may be subsequently made by those skilled in the art, and are also intended to be encompassed by the disclosed embodiments. As such, various changes and omissions from the described embodiments may be made without departing from the spirit and scope of this disclosure, which is defined by the claims.

What is claimed is

1. A method for treating water to remove urea from the water, the method comprising:
adding a sufficient amount of a pH adjusting agent to the water to control the pH of the water to be in a range of from 3.5 to 5;
adding a chlorine-containing agent to the water; and
then irradiating the water with UV radiation to decompose the urea in the water so that at least 60% of the urea in the water is removed.

2. The method according to claim 1, wherein the water is irradiated with UV radiation to decompose the urea so that at least 75% of the urea in the water is removed.

3. The method according to claim 1, wherein the water is irradiated with UV radiation to decompose the urea so that the water has less than 25 ppb of urea.

4. The method according to claim 1, wherein the water is irradiated with UV radiation to decompose the urea so that the water has less than 5 ppb of urea.

5. The method of claim 1, wherein the UV radiation has a wavelength of 254 nm.

6. The method of claim 1, wherein the pH of the water is controlled to be in a range of from 4 to 5.

7. The method of claim 1, further comprising adding a second pH adjusting agent to the water after it is irradiated with the UV radiation to increase the pH of the UV-treated water to range of from 5.5 to 8.5.

8. The method of claim 1, further comprising removing ions from the water with an ion exchange device or deionization device after irradiating the water with UV radiation.

9. The method of claim 1, wherein after adding the pH adjusting agent to the water and after adding the chlorine-containing agent to the water, further comprising a step of holding the water for a predetermined period of time prior to irradiating the water with the UV radiation.

10. The method of claim 9, wherein the predetermined period of time is in a range of 2 minutes to 1 hour.

11. A system for treating a water stream to remove urea from the water stream, the system comprising:
a UV reactor that is configured to receive the water stream and irradiate it with UV radiation to provide a UV-treated water stream;
an acid source that is arranged upstream of the UV reactor and is configured to add acid to the water stream;
a chlorine source that is arranged upstream of the UV reactor and is configured to add a chlorine-containing agent to the water stream;
a controller that includes a processor;
an upstream pH meter that is arranged upstream of the UV reactor and is configured to measure the pH of the water stream and send a signal to the controller based on the measured pH; and
an upstream TOC analyzer that is arranged upstream of the UV reactor and is configured to measure a TOC concentration in the water stream and send a signal to the controller based on the measured TOC concentration,
wherein the controller is configured to compare the measured TOC concentration with a threshold value, and if the measured TOC concentration exceeds the threshold value, (i) send a control signal to control the acid source based on the measured pH so that an amount of acid is added to the water stream to control the pH to be in a range of from 3.5 to 5; and (ii) send a control signal to control the chlorine source so that the chlorine-containing agent is added to the water stream.

12. The system of claim 11, wherein the controller is configured to send the control signal to control the chlorine source so that an amount of the chlorine-containing agent that is added to the water stream is based on the measured TOC concentration from the upstream TOC analyzer.

13. The system of claim 11, further including an upstream chlorine analyzer that is arranged upstream of the UV reactor and downstream of the chlorine source, and is configured to measure an amount of free chlorine in the water stream.

14. The system of claim 13, wherein the upstream chlorine analyzer is configured to send a signal to the controller based on the measured amount of free chlorine, and the controller is configured to send a control signal to the chlorine source to control an amount of the chlorine-containing agent that is added to the water stream based on the measured amount of free chlorine.

15. The system of claim 11, further including a base source that is arranged downstream of the UV reactor and is configured to add a base to the UV-treated water stream.

16. The system of claim 15, further comprising a downstream pH meter that is located downstream of the base source and is configured to measure the pH of the UV-treated water stream and send a signal to the controller based on the measured pH value.

17. The system of claim 16, wherein the controller is configured to send a control signal to the base source based on the measured pH value from the downstream pH meter so that a sufficient amount of the base is added to the UV-treated water stream to control the pH to be in a range of from 5.5 to 8.5.

18. The system of claim 15, further including an ion exchange device or deionization device that is arranged downstream of the base source and is configured to remove ions from the UV-treated water stream.

19. The system of claim 11, further including a downstream TOC analyzer that is arranged downstream of the UV reactor and is configured to measure the TOC of the UV-treated water stream and send a signal to the controller based on the measured TOC value.

20. The system of claim 19, wherein, based on the signal from the downstream TOC analyzer, the controller is configured to send a control signal to control at least one of (i) an amount of the UV radiation emitted by the UV reactor; (ii) a flow rate of the water stream through the UV reactor; and (iii) an amount of the chlorine-containing agent that is added to the water stream.

21. The system of claim 11, further comprising a downstream chlorine analyzer that is arranged downstream of the UV reactor and is configured to measure an amount of free chlorine in the water stream downstream of the UV reactor and send a signal to the controller based on the measured amount of free chlorine.

22. The system of claim 21, wherein, based on the signal from the downstream chlorine analyzer, the controller is configured to send a control signal to control at least one of (i) an amount of the UV radiation emitted by the UV reactor; (ii) a flow rate of the water stream through the UV reactor; and (iii) an amount of the chlorine-containing agent that is added to the water stream.

23. The system of claim 21, further comprising a quenching agent source that adds a quenching agent to the water stream downstream of the UV reactor, wherein the quenching agent is able to degrade free chlorine in the water stream, and wherein the controller is configured to control an amount of the quenching agent that is added to the water stream based on the control signal from the downstream chlorine analyzer.

24. The system of claim 11, further comprising a flow meter that is configured to measure a flow rate of the water stream and send a signal to the controller based on the measured flow rate.

25. The system of claim 24, wherein the controller sends the control signal to control the chlorine source so that the amount of the chlorine-containing agent that is added to the water stream is also based on the measured flow rate.

26. The system of claim 11, further comprising a holding tank or holding conduit that is arranged downstream of the acid source and the chlorine source and upstream of the UV reactor, which is configured to receive the water stream and hold the water for a time period in a range of from 2 minutes to 1 hour before it is sent to the UV reactor.

27. A system for treating a water stream to remove urea from the water stream, the system comprising:
a UV reactor that is configured to receive the water stream and irradiate it with UV radiation to provide a UV-treated water stream;
an acid source that is arranged upstream of the UV reactor and is configured to add acid to the water stream;
an oxidant source that is arranged upstream of the UV reactor and is configured to add an oxidant to the water stream;
a controller that includes a processor;
an upstream pH meter that is arranged upstream of the UV reactor and is configured to measure the pH of the water stream and send a signal to the controller based on the measured pH; and
an upstream TOC analyzer that is arranged upstream of the UV reactor, and includes (i) a first TOC analyzer that is sensitive to urea that is configured to measure a first TOC concentration of the water stream and send a signal to the controller based on the measured first TOC concentration; (ii) a second TOC analyzer that is not sensitive to urea that is configured to measure a second TOC concentration of the water stream and send a signal to the controller based on the measured second TOC concentration;
wherein the controller is configured to calculate a difference between the measured first TOC concentration and the measured second TOC concentration, and if the difference exceeds a threshold value, (i) send a control signal to control the acid source based on the measured pH so that an amount of acid is added to adjust the pH of the water stream; and (ii) send a control signal to control the oxidant source so that the oxidant is added to the water stream.

28. The system according to claim 27, wherein the controller is configured to send a control signal to the acid source based on the measured pH to control the pH of the water stream to be in a range of from 3.5 to 5.
